(19) United States
(12) Patent Application Publication
(10) Pub. No.: US 2025/0005430 A1
(43) Pub. Date: Jan. 2, 2025

(54) ARTIFICIAL-INTELLIGENCE MODELING UTILITY SYSTEM

(71) Applicant: Microsoft Technology Licensing, LLC, Redmond, WA (US)

(72) Inventors: Vikram Gaitonde, Sunnyvale, CA (US); Peter Michael Humke, Pearland, TX (US); Michael E. Pascual, Santa Clara, CA (US); Smriti R. Ramakrishnan, Belmont, CA (US); Ajith Muralidharan, Sunnyvale, CA (US); Yao Pan, Mountain View, CA (US); Lingjie Weng, Sunnyvale, CA (US); Keren Wang, Santa Clara, CA (US); Anjian Wu, Newark, CA (US); Daniel Chi Peng Lau, San Francisco, CA (US)

(21) Appl. No.: 18/216,042

(22) Filed: Jun. 29, 2023

(51) Int. Cl. G06N 20/00; G06F 9/451

(52) U.S. Cl. CPC G06N 20/00; G06F 9/451

(57) ABSTRACT

Methods, systems, and computer programs are presented for implementing an artificial-intelligence modeling utility system. One method includes receiving, by a modeling manager, a schema from an experience module that implements features of an online service. The modeling manager manages a plurality of machine-learning (ML) models, provides a user interface (UI) based on the schema for entering experiment parameter values, and configures one or more ML models for the experiment. The experiment is initialized, and during the experiment, the modeling manager receives a request from the experience module for data associated with the experiment and selects one of the configured ML models for providing a response to the request. The response is obtained from the selected ML model based on input provided to the ML model based on the request, and the modeling manager sends the response to the experience. Further, results of the experiment are presented.

### TECHNICAL FIELD

The subject matter disclosed herein generally relates to methods, systems, and machine-readable storage media for a system that provides tools to utilize Artificial-Intelligence (AI) models and create experiments to determine model performance.

### BACKGROUND

An online service may provide multiple products to multiple types of users, and the different product teams are constantly developing new product features that may be addressed to multiple audience types. Each product team wishes to test the new product features, typically by setting up experiments, each experiment using a different type of modeling, having different features, and being offered to different audiences. Based on the results of the experiments, the product teams determine which product features increase value and which models perform better to determine desired goals for introducing the new product features.

Testing each new product feature may be resource expensive as each test requires developers to define the features, set up the models, configure the tests, and then track the tests. In a large online service, there could be hundreds or thousands of different new features being considered, so it may become very expensive to develop and test all the new features.

### BRIEF DESCRIPTION OF THE DRAWINGS

Various of the appended drawings merely illustrate example embodiments of the present disclosure and cannot be considered as limiting its scope.

FIG. 1 illustrates a screenshot of a user page, according to some example embodiments.

FIG. 2 illustrates the User Interface (UI) of an Artificial Intelligence Modeling Manager (AIMM), according to some example embodiments.

FIG. 3 is a UI for entering parameters to customize an experiment, according to some example embodiments.

FIG. 4 is a UI for configuring the experiment, according to some example embodiments.

FIG. 5 presents a portion of the configuration UI for entering the variant values, according to some example embodiments.

FIG. 6 illustrates the process for configuring another experiment for an email application, according to some example embodiments.

FIG. 7 illustrates another example for entering variants in a premium-upsell application, according to some example embodiments.

FIG. 8 is a sample interface for presenting experiment results, according to some example embodiments.

FIG. 9 is a high-level architecture for the AIMM, according to some example embodiments.

FIG. 10 is a block diagram illustrating a networked architecture, according to some example embodiments.

FIG. 11 is a diagram illustrating the use of the AIMM and the interactions with the experience applications of the social networking server, according to some example embodiments.

FIG. 12 is a flowchart of a method for setting up an experiment, according to some example embodiments.

FIG. 13 is a flowchart of a method for using the AIMM tool during the experiment, according to some example embodiments.

FIG. 14 illustrates the training and use of a machine-learning model, according to some example embodiments.

FIG. 15 is a flowchart of a method for implementing an artificial-intelligence modeling utility system, according to some example embodiments.

FIG. 16 is a block diagram illustrating an example of a machine upon or by which one or more example process embodiments described herein may be implemented or controlled.

### DETAILED DESCRIPTION

Example methods, systems, and computer programs are directed to implementing an artificial-intelligence modeling utility system. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

In one aspect, an AI Model Marketplace (AIMM) is provided with features to define feature options, select AI models, and set up experiments for testing the new features. Developers can leverage the relevant AI models to improve member experience and boost impact without additional engineering work requiring coding to set up the AI models. For example, a developer may select one or more models to improve email messages, and another developer may select other models for selecting feed messages to encourage users to add additional features to their subscriptions. Further, developers may define the type of audience selected for each experiment. A User Interface (UI) is provided to enable developers to personalize their modeling and configure models and experiments without having to write new programs.

For the purposes of this description the phrases “an online social networking application” and “an online social network system” may be referred to as and used interchangeably with the phrases “an online system,” “an online service,” “a networked system,” or merely “a connections network.” It will also be noted that a connections network may be any type of an online network, such as, a professional network, an interest-based network, or any online networking system that permits users to join as registered members. For the purposes of this description, registered members of a connections network may be referred to as simply members or users, and some un-registered users may also access the services provided by the online service. As used herein, a “user” refers to any person accessing the service, either registered or unregistered. Further, some connections networks provide services to their members (e.g., search for jobs, search for candidates for jobs, job postings) without being a social network, and the principles presented herein may also be applied to these connection networks.

One general aspect includes a computer-implemented method that includes an operation for receiving, by a modeling manager, a schema from an experience module, where the experience module implements one or more features of an online service. The schema is a data structure that defines variables for an experiment, and the modeling manager manages a plurality of machine-learning (ML) models. The method further includes providing, by the modeling manager, a first user interface (UI) based on the schema for entering parameter values for the experiment, and configuring one or more ML models from the plurality of ML models for the experiment based on the parameter values entered on the first UI. The experiment is initialized, and during the experiment, the modeling manager receives a request from the experience module for data associated with the experiment and selects one of the configured ML models for providing a response to the request. The response is obtained from the selected ML model based on input provided to the ML model based on the request. The modeling manager sends the response to the experience. Further, a second UI is provided for presenting results of the experiment.

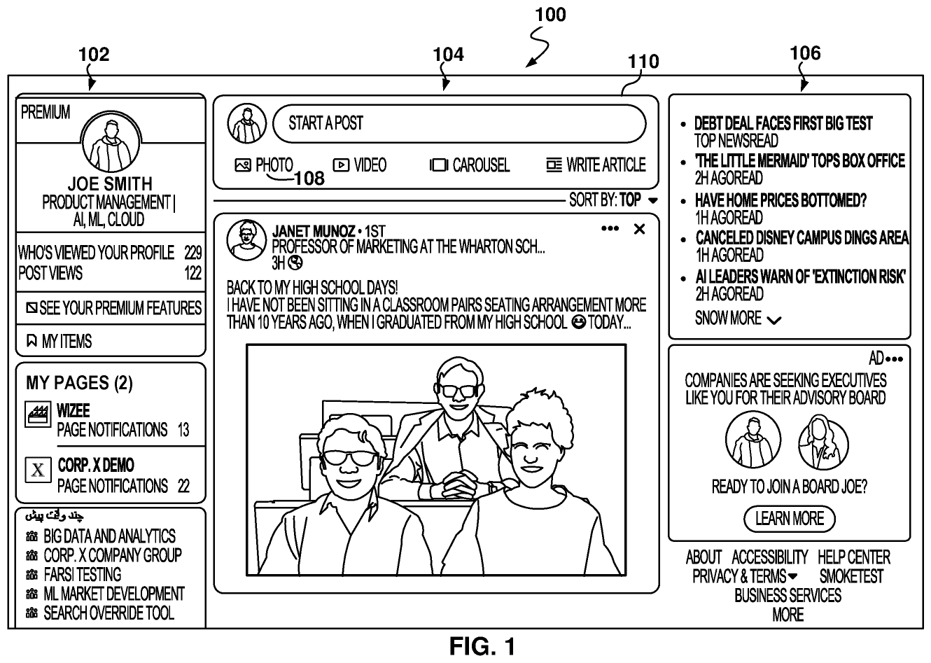

FIG. 1 illustrates a screenshot of a user page 100, according to some example embodiments. In the illustrated example, the user, named Joe Smith, may be a creator of content and a viewer of content generated by other users.

The user page includes a user area 102, a user feed 104, and an announcements area 106. The user area 102 includes information about the user (e.g., name, picture, title), recent activity, groups, events, followed hashtags, My pages, etc. The announcements area 106 includes miscellaneous items, such as announcements, new, tips, help assistance, etc.

The user feed 104 can include various categories such as a start-post field 110 (e.g., add a post with a photo 108), user posts, job recommendations, suggestions for adding new connections (e.g., People You May Know [PYMK]), notifications, sponsored items, shortcuts, news, messages, articles, and the like.

If the user selects the option to start a post, the user may enter text, a photo, or another item (e.g., a video) to create the post. After the user completes the post, the post is presented to connections of the user or is made public for the whole community to access.

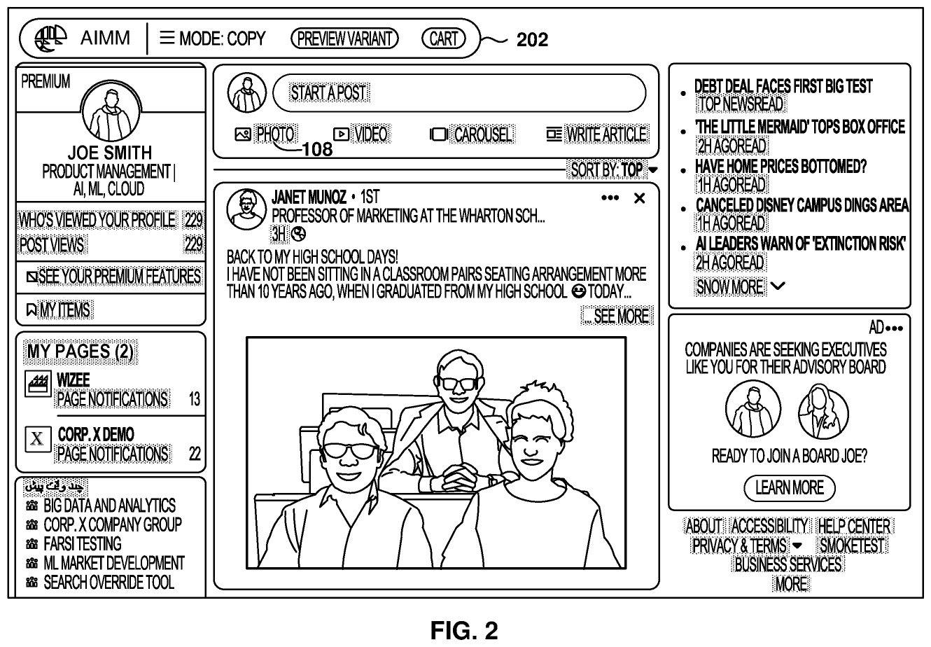

FIG. 2 illustrates the User Interface (UI) of an Artificial Intelligence Modeling Manager (AIMM), according to some example embodiments. In some example embodiments, the UI includes a toolbar 202 with the AIMM options, which is displayed over the UI associated with the experience that is to test a new feature, such as the user page 100 of FIG. 1. In some example embodiments, the toolbar 202 is implemented as a browser extension, and when the developer selects the browser extension, the toolbar 202 is presented on the current webpage (e.g., webpage including the user page 100), but other embodiments may utilize other type of interfaces to configure the experiment.

In some example embodiments, the toolbar 202 includes the AIMM options, e.g., select mode, preview variant, go to cart. When the developer activates the toolbar 202, AIMM highlights the strings that are selectable for modeling. In the illustrated example, the selectable strings are presented with a different shading, but other embodiments may use other indicators, such as different color, bounding boxes, etc.

In the illustrated example, the developer in charge of increasing the number of clicks on the feed is exploring variations for the word “Photo” 108. A photo may also be referred to by other names, such as image, selfie, snapshot, shot, etc. The developer wants to determine if using a different word in the user page 100 may increase traffic. It is believed that different users may respond better to different words, so that experimentation will account for the characteristics of the user viewing the user page 100. In some embodiments, an experiment refers to a process to determine the efficiency of a service feature provided by the online service, and the experiment includes testing the performance of a machine-learning model with reference to one or more metrics (e.g., increase number of responses to a communication) for a specified segment of users, where the users of the segment share one or more characteristics that define inclusion in the segment. As used herein, a test is the same as an experiment.

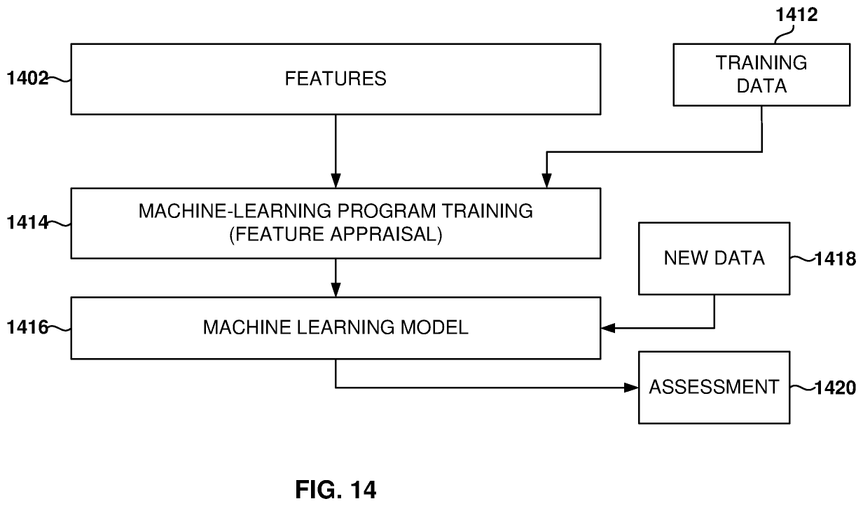

The developer uses AIMM to set up the experiments for determining if different sets of users and different models associated with the different sets of users may increase click-throughs. A machine-learning model, also referred to herein simply as model, is a program, resulting from training a machine-learning algorithm, that makes predictions or decisions expressed as outputs or assessments. More details regarding machine learning models are provided below with reference to FIG. 14.

Because different models utilize different structures, configurations, training sets, features, etc., some models will make better predictions than others based on the configuration and properties of the model. AIMM provides a suite of models with different parameters, and the developer would like to know which model would perform better for the desired goal (e.g., using a different word for photo in some user feeds to increase traffic). In some instances, the AIMM is capable of concurrently executing multiple models targeted at different sets of users, and, thereafter, evaluating the performance of each of the concurrently executed models.

AIMM allows developers to easily add any new features for customization such as email, notifications, signup page, feed, profile, search, etc. The developers are able to target new user features within any of the existing product flows, e.g., new subject line for emails to users, add creative images in sign-up pages, etc. The developers are also able to ramp these variants with one or more models. In some embodiments, the developers are able to concurrently ramp variants with multiple models and, subsequently, evaluate their performance.

The addition of new feature flows and new models can be done without engineering work and is fully integrated with A/B testing that shows developers the impact of each AI-model, and provides performance metrics to compare the efficiency of the different models.

Without AIMM and the embodiments described herein, the developers would have to integrate their AI models into each feature they wanted to optimize, which is time consuming and not reusable. Additionally, the developers have to create all the variants to be tested and target each variant to a user segment, to be able to manually pick the best variant. Furthermore, the developers would have to write code for each of the variants to be tested. With AIMM, the models can be reused for different use cases, so the product teams do not have to worry about creating a new model each time a new feature is desired. Also, AIMM can test several models at the same time by serving a fraction of the requests by each of the models.

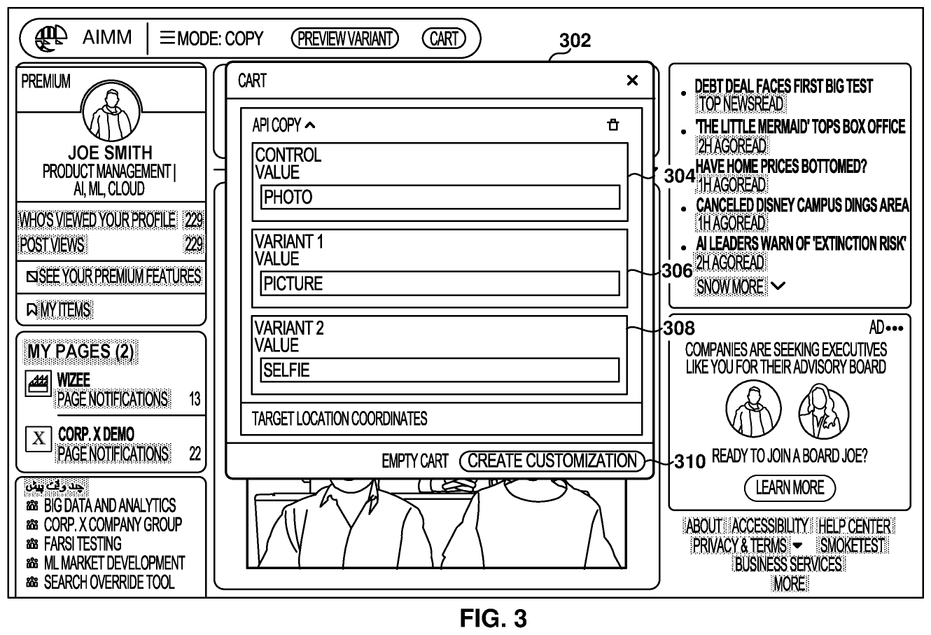

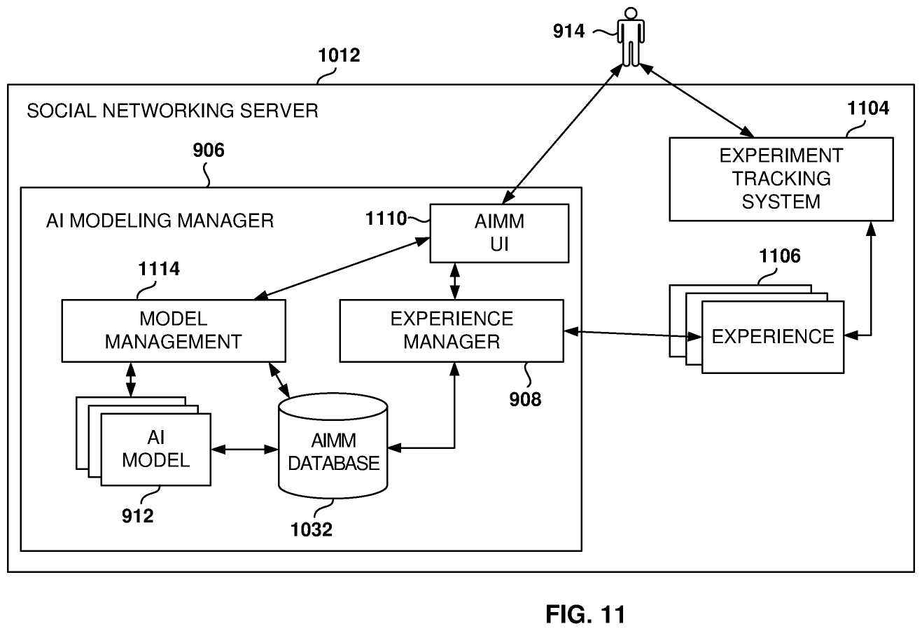

FIG. 3 is a UI for entering parameters to customize an experiment, according to some example embodiments. After the developer selects the photo 108 option in the UI of FIG. 2, AIMM provides configuration window 302 to fill in the information for creating a custom experiment, also referred to as a customization. The options in the configuration window 302 are based on a schema previously configured by the experience associated with the developer accessing AIMM, as described in more detail below with reference to FIG. 11.

In the example illustrated in FIG. 3, the customization includes the control value 304 (e.g., “Photo:), a first variant 306 for an alternate text to the control value (e.g., “Picture”), and a second variant 308 for a second alternate text for the control value (e.g., “Selfie”).

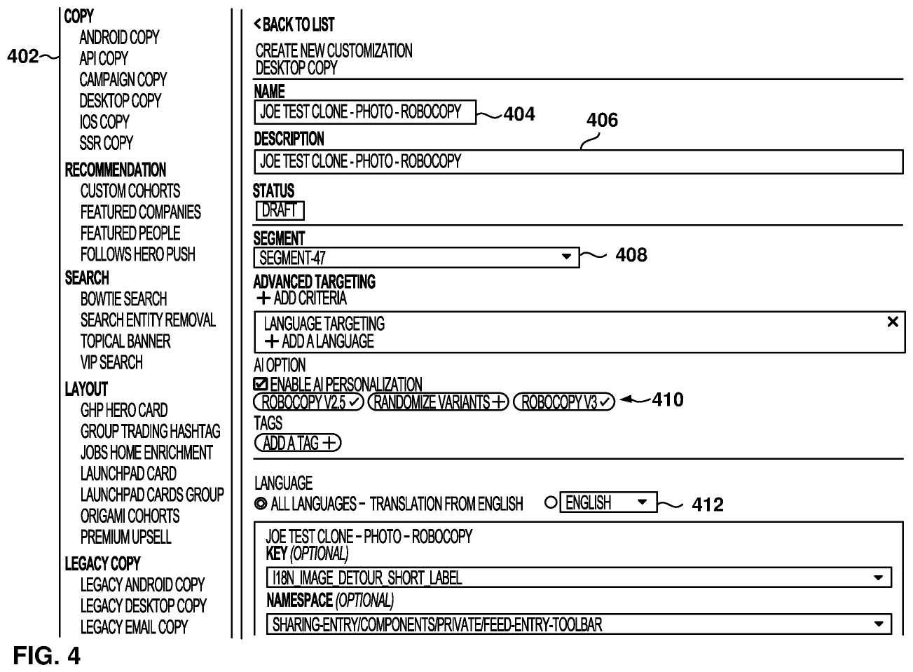

After the developer enters the configuration information in the configuration window 302, the developer can select create-customization button 310 to initialize the experiment. The developer is then presented the UI described below with reference to FIG. 4 to configure the experiment.

The first variant and the second variant are the variants defined for this experiment. The purpose of the experiment is to determine if the use of one of the variants, for a segment of users, may improve the desired performance metric. Therefore, there is a control variant (the original term) and two different variants that will be tested with the members of the online service.

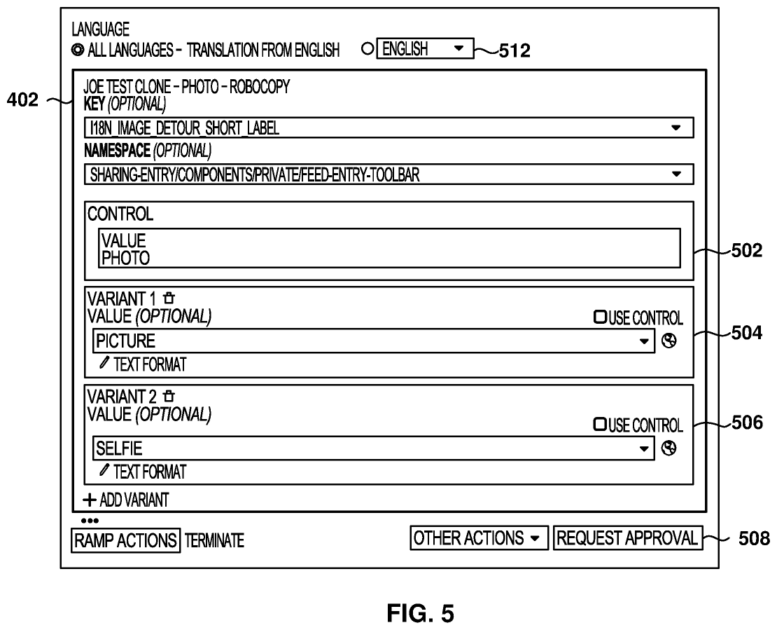

FIG. 4 is a UI 402 for configuring the experiment, according to some example embodiments. The UI 402 is presented in FIGS. 4 and 5, with FIG. 4 presenting the top portion of the UI 402 and FIG. 5 presenting the bottom portion of the UI 402.

The configuration page includes option 404 for entering the name, option 406 for entering a description of the experiment, option 408 for identifying a segment of the population targeted for the experiment, an option 410 to choose one or more models for the experiment, and an option 412 for selecting the language.

In this example, three models are available, named Robocopy v2.5, Randomize Variants, and Robocopy v3. The Robocopy models are models that select the text (i.e., copy) to be used in each message sent to a user. The Randomize Variants is a model that generates a random choice, from the list of choices, to select the text for each message. There are two versions of the Robocopy models, and the developer would want to determine which model performs better according to certain criteria (e.g., increase number of responses). In some examples, the developer is capable of using the UI 402 for concurrently executing multiple Robocopy models and evaluating their respective results.

FIG. 5 presents the portion of the configuration UI 402 for entering the variant values, according to some example embodiments. The values previously entered in the configuration window 302 are populated in the UI 402 and the developer can change the control value 502, the value of the first variant 504, and the value of the second variant 506.

Once the configuration is complete, the developer may select the request-approval button 508 to initiate the experiment, and then the information is processed by an administrator to validate the experiment. In other embodiments, a start-experiment button is provided instead, and the experiment gets created automatically without having to go through the approval process.

In this example, the two Robocopy models have been selected, and when the test is run, a percentage of users of the online service (e.g., 5%) will be shown the values chosen by Robocopy v2.5, and another percentage of users (e.g., 5%) will be shown the values chosen by Robocopy v3. The percentage of users for each experiment is configurable and may be changed for each experiment. This means that during the experiment, some users will see the word “Photo” in the user feed, some will see the word “Picture,” and some will see the word “Selfie.”

During the experiments, when a model is selected, the model will select the right term for the user, based on the parameters configured in the model and the input provided by the experience.

For example, a 22-year-old woman is active in the marketing space, and the woman posts many selfies, more often than other types of images. Thus, the word “Selfie” may be tested with this woman to check if it would cause an increase in the number of interactions by this user.

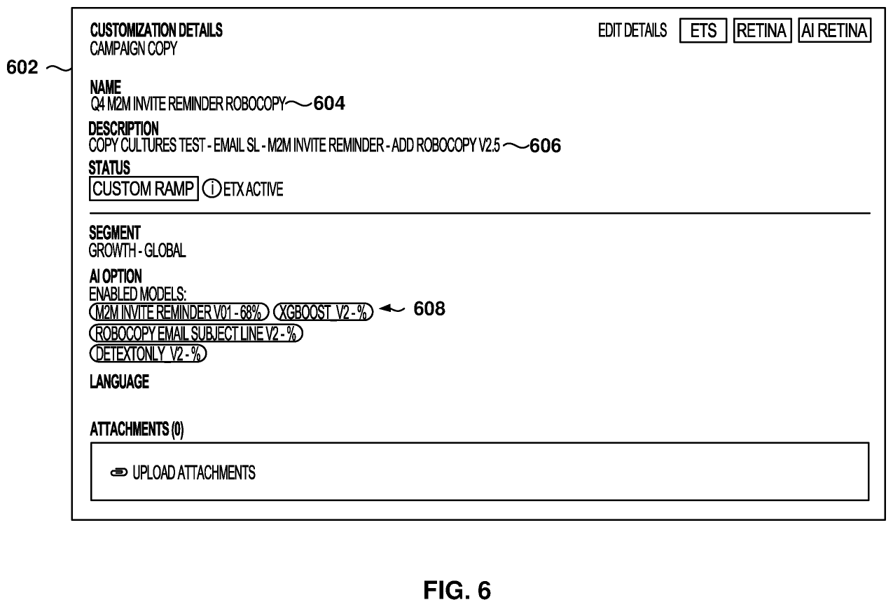

FIG. 6 illustrates the process for configuring another experiment for an email application, according to some example embodiments. In this example, AIMM is used to generate text for an email message to invite a user to connect to another user (also referred to herein as member-to-member invitation). The UI 602 is the configuration UI for this test.

The name 604 for the experiment has been entered as “Q4 M2M Invite Reminder Robocopy”, and the description 606 reads, “Copy Cultures Test—Email SL-M2M Invite Reminder-Add Robocopy v2.5.”

In this case, there are four available models 608, named “m2m invite reminder v 01,” “xgboost_v2, “Robocopy email subject line v2,” and “detextOnly_v2.”

Some users get invitations to connect with other users, and the online service sends periodic reminders about the pending invitations, so the user can accept or reject the invitations. For example, “Joe, there are 16 invitations pending for you.” In this experiment, the subject line of the email reminder is selected by one of the models. The goal of the experiment is to determine which of the models provides suggestions that increase the probability that the user responds to the reminder.

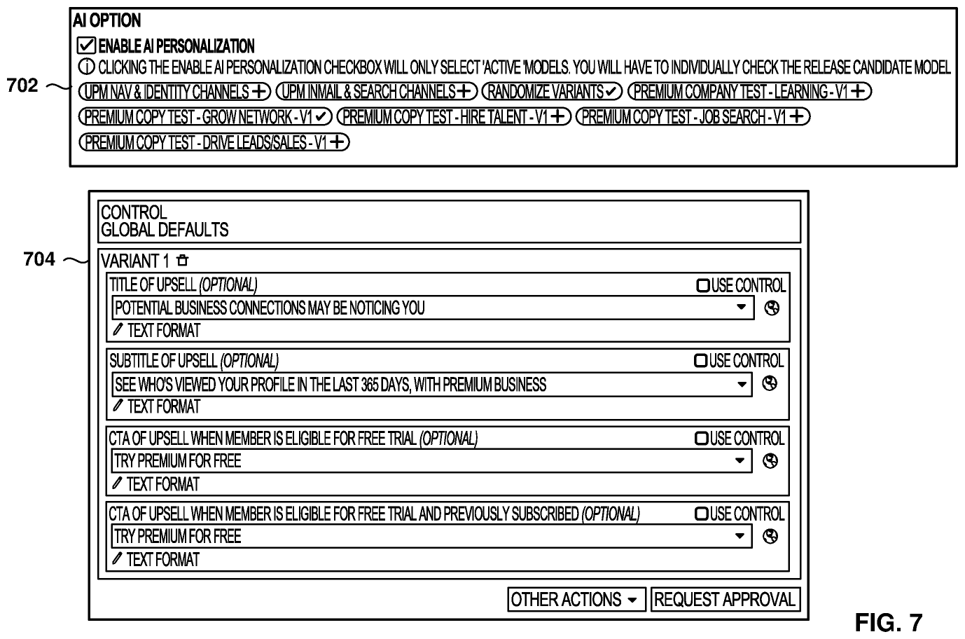

FIG. 7 illustrates another example for entering variants in a premium-upsell application, according to some example embodiments. In this example, the developer wishes to increase sales of a premium product targeted to recruiters looking to hire. The example is referred to as premium upsell.

The invitations to upgrade the service level are sent to candidates via different mechanisms, such as email, in-service communication, text message, etc. The models are configured to select the text for the notification.

The UI 702 shows the configuration section for selecting the model. In this case, there are eight choices, and the developer has selected two models: “Randomize Variants” and “Premium Copy Test—Grow Network—V1.”

The UI 704 presents the options for configuring this experiment, which include a Variant 1 with multiple fields: title of upsell, subtitle of upsell, CTA of upsell when member is eligible for free trial, and CTA of upsell when member is eligible for tree trial and previously subscribed. It is noted that this experiment has more fields because the schema to configure this type of experiment included these fields.

The AIMM system may be used in other types of examples, such as recommending search topics based on the user intent, driving engagement rate by dynamically choosing the best cohorts presented on company and profile pages, selecting the most useful talent insights, changing the order of follows and connections in discovery pages to increase engagement, driving engagement on profile pages by personalizing page layout based on user intent, curate a learning curriculum from predefined choices for users, recommend articles on the user feed to increase interactions, etc.

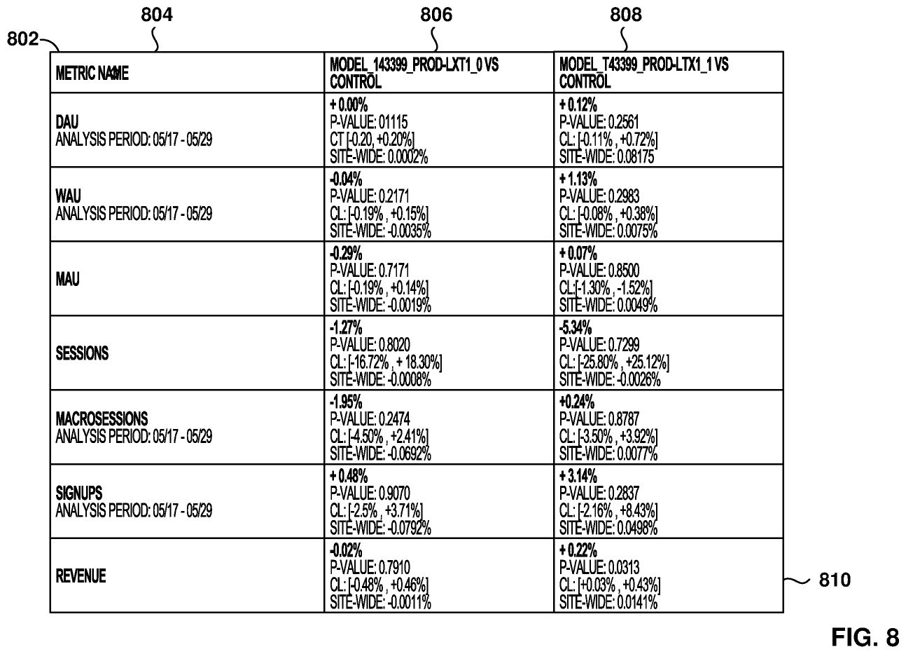

FIG. 8 is a sample UI 802 for presenting experiment results, according to some example embodiments. After an experiment is run, multiple types of reports are available to describe the results. In the illustrated example, the UI 802 presents results in a table with one experiment per row, with the name of the measured metric in the first column 804, the results for a first model 806 in the second column, and the results for a second model 808 in the third column. The results show the comparison with the control variable.

For each model and metric, the results include a percentage change in the objective by using the model, a p value, and other experiment data. The p-value is a statistical measure used to determine the significance of a relationship between two variables, where a low p-value indicates that there is a strong relationship between the variables, while a high p-value indicates that there is no significant relationship. P-values are often used to evaluate the performance of a machine learning model. A low p-value for a model indicates that the model is likely to make accurate predictions, while a high p-value indicates that the model is likely to make inaccurate predictions.

In the illustrated example, results 810 are shown for metric “Total Macrosessions” and model “Model_143399_prod-ltx1_v1 vs Control.” The results 810 show a low p-value of 0.0313, which shows that the improvement is statistically significant. The developer may then decide to use this model in production due to the improvement showed by the model to increase the number of sessions by users of the online service.

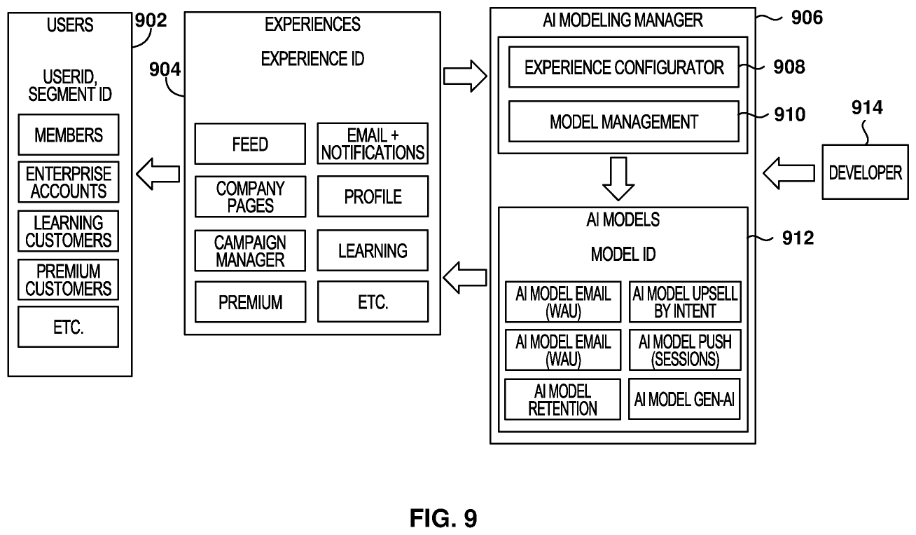

FIG. 9 is a high-level architecture for the AIMM 906, according to some example embodiments. The users 902 include the entities accessing the online service, such as members, enterprise accounts, learning customers, premium customers, etc. Each user is assigned a user ID (Identifier).

Further, the users 902 may be segmented for different purposes, and each segment is assigned a segment ID. A segment defines a plurality of users with a shared characteristic. The characteristics to define segments may be of different types, such as demographics (age, geographic location, time zone, country), language, work title, type of customer (premium user vs. non-paying subscribers), status on the online service, (e.g., number of followers, number of connections), etc.

Experiences 904 refer to the different product offerings of the online service, such as user feed, emails and notifications, company pages, profile pages, campaign manager, learning product (education), premium selling service, etc. Each experience is assigned an experience ID. As used herein, an experience is a program that implements one or more features of the online service. In some embodiments, an experiment may use one or more models that are differentiated from each other based on one or more features.

The developer 914 is the person (e.g., a product manager) associated with an experience offered by the online service. The developer 914 interacts with the AIMM 906 to configure experiments and take advantage of the AI modeling services provided by the AIMM 906. The developer 914 may add additional experience IDs by submitting a request to the AIMM 906. The developer does not have to be an experienced programmer because no coding expertise is required to execute the AIMM.

The AIMM 906 includes an experience manager 908, a model management module 910, and the AI models 912. Each AI model 912 is assigned a model ID. The experience manager 908 manages the setup and configuration of new tests during experiments, including processing a schema received from a developer 914 to configure a test.

In general, a schema is a data structure that defines the structure of data, such as the structure of data in a database. For AIMM 906, the schema defines the parameters of the test, and the AIMM creates the configuration pages to enter the variants based on the schema defined by the developer 914. The schema defines the tables, columns, and relationships between the data in the experiment.

The model management module 910 is in charge of the management of the AIMM 906, including providing APIs for receiving requests, setting up the UIs for the developers, etc. More details on the AIMM 906 are provided below with reference to FIG. 11.

The AI models 912 include the models available for experimentation, such as models for text of email messages, text on a UI, text for text messages, text for invitations, etc., and each model may be configured to improve one or more objectives, such as increase number of sessions, increase number of responses, increase number of invitations sent, increase number of service upgrades, increase user retention, etc.

The AIMM 906 allows developers 914 to optimize experiences (without having to code new programs), select one or more AI models 912, select the desired user ID, and select the segment ID for the experimentation. AIMM 906 sets up the models to automatically learn user preferences and generate estimates in real-time to optimize the experience for each developer 914.

AIMM 906 allows a large audience to be segmented and served by audience specific models, e.g., a member-to-member invite reminder email could be optimized by geography (e.g., India, USA), and each country could be served by a country specific model.

Further, the AIMM 906 allows for faster product feature additions by decoupling the features from the AI models, e.g., notification emails powered by one AI model could be migrated to a new AI model without any additional engineering development required by the developer.

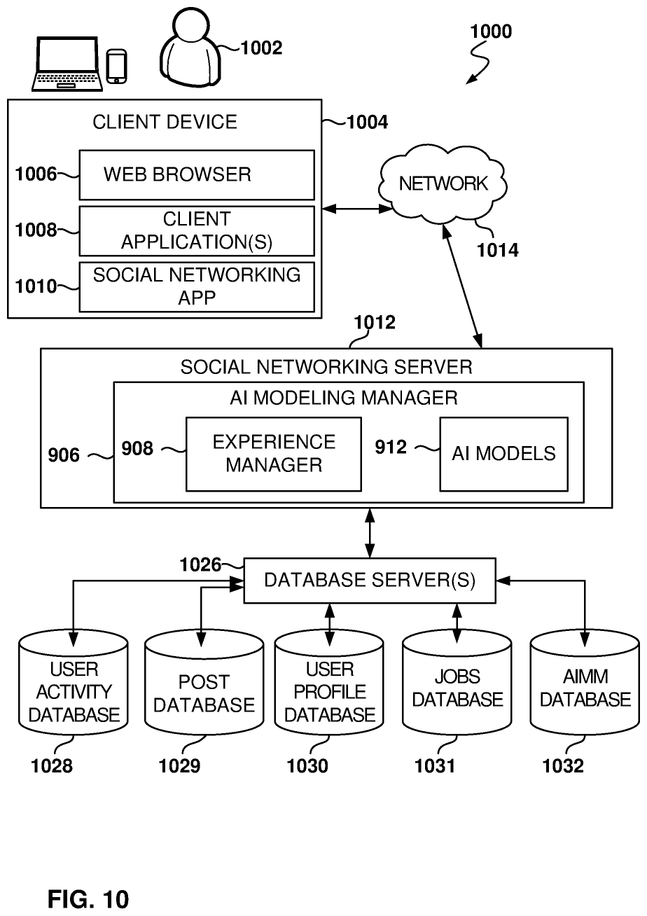

FIG. 10 is a block diagram illustrating a networked architecture 1000, according to some example embodiments. The networked architecture 1000 includes a networking server 1012, illustrating an example embodiment of a high-level client-server-based network architecture. Embodiments are presented with reference to an online service, and, in some example embodiments, the online service is a social networking service.

The social networking server 1012, a distributed system comprising one or more machines, provides server-side functionality via a network 1014 (e.g., the Internet or a wide area network (WAN)) to one or more client devices 1004. FIG. 10 illustrates, for example, a client device 1004 with a web browser 1006, client application(s) 1008, and a social networking app 1010 executing on the client device 1004. The social networking server 1012 is further communicatively coupled with one or more database servers 1026 that provide access to one or more databases 1028-1032.

The social networking server 1012 includes, among other modules, the AIMM 906, which includes, at least, the experience manager 908 and the AI models 912.

The client device 1004 may comprise, but is not limited to, a mobile phone, a desktop computer, a laptop, a tablet, a netbook, a multi-processor system, a microprocessor-based or programmable consumer electronic system, or any other communication device that the user 1002 may utilize to access the social networking server 1012. In some embodiments, the client device 1004 may comprise a display module (not shown) to display information (e.g., in the form of user interfaces).

In one embodiment, the social networking server 1012 is a network-based appliance, or a distributed system with multiple machines, which responds to initialization requests or search queries from the client device 1004. One or more users 1002 may be a person, a machine, or other means of interacting with the client device 1004. In various embodiments, the user 1002 interacts with the networked architecture 1000 via the client device 1004 or another means.

In some embodiments, if the social networking app 1010 is present in the client device 1004, then the social networking app 1010 is configured to locally provide the user interface for the application and to communicate with the social networking server 1012, on an as-needed basis, for data and/or processing capabilities not locally available (e.g., to access a user profile, to authenticate a user 1002, to identify or locate other connected users 1002, etc.). Conversely, if the social networking app 1010 is not included in the client device 1004, the client device 1004 may use the web browser 1006 to access the social networking server 1012.

In addition to the client device 1004, the social networking server 1012 communicates with the one or more database servers 1026 and databases. In one example embodiment, the social networking server 1012 is communicatively coupled to a user activity database 1028, a post database 1029, a user profile database 1030, a jobs database 1031, and an AIMM database 1032.

The user activity database 1028 keeps track of the activities of the users in the online service, and the post database 1029 keeps information about the posts generated by users, including the posts added to groups. The user profile database 1030 keeps profile information about the users. The jobs database 1031 keeps information jobs listed in the online service, and the AIMM database 1032 keeps the information stored by the users 902, such as model information, configured experiments, developer schemas, experiments being deployed, training data, developer data, etc.

In some example embodiments, when a user 1002 initially registers to become a user 1002 of the social networking service provided by the social networking server 1012, the user 1002 is prompted to provide some personal information, such as name, age (e.g., birth date), gender, interests, contact information, home town, address, spouse's and/or family users' names, educational background (e.g., schools, majors, matriculation and/or graduation dates, etc.), employment history (e.g., companies worked at, periods of employment for the respective jobs, job title), professional industry (also referred to herein simply as “industry”), skills, professional organizations, and so on. This information is stored, for example, in the user profile database 1030. Similarly, when a representative of an organization initially registers the organization with the social networking service provided by the social networking server 1012, the representative may be prompted to provide certain information about the organization, such as a company industry.

Some operations may be performed on the client device 1004 instead of the social networking server 1012, e.g., the AI models may execute on a mobile phone utilizing processors and Graphics Processing Units (GPUs) of the mobile phone.

FIG. 11 is a diagram illustrating the use of the AIMM 906 and the interactions with the experience applications of the social networking server, according to some example embodiments. The AIMM 906 integrates with each of these different experiences 1106 that power different features that exist on the online service, and then the AI models 912 may be used by the experiences 1106.

In some example embodiments, the AIMM 906 provides Application Programming Interfaces (APIs) to exchange commands and data with the experiences 1106. Initially, the experiences 1106 sends a schema to the experience manager 908 to define the parameters for the experiment, such as the control variable and one or more variants.

The experience manager 908 takes the received schema and creates a new experiment. The information for the new experiment stored in the AIMM database 1032, and when the developer 914 invokes the creating of a new experiment, the AIMM UI 1110 for configuring the experiment is created based on the schema definition.

The model management 1114 automatically trains the models, generates scoring data, and configures the AI models 912 to optimally target the variants to each member of the target segment.

While one experiment is running, the corresponding models 912 determines an item (e.g., a text message, a word, an image) based on experiment and user data and the item is transferred back to the experience 1106. The experience 1106 receives the item generated by the model 912 and then uses the item in the normal flow of operations for the corresponding experiences.

The AIMM 906 provides multiple AI models 912 so the developers have choices for selecting models based on the goal. Some models may be geared towards webpages and other towards email communications: some models may be used for driving clickthroughs, while other models are geared towards increasing revenue, etc.

Once the experiment begins, the experiment information is transmitted to the experiment tracking system 1104 that tracks the messages sent by the different experiences 1106 and the responses from the users. The experiment tracking system 1104 provides reporting utilities for examining the experiment results, such as the UI shown in FIG. 8. When the experience invokes the AIMM 906 to get an item, the AIMM 906 returns data, referred to as payload, and the payload includes information for the experiment tracking system 1104, so when messages are sent, the responses can be tracked by the experiment tracking system 1104.

Although one AIMM database 1032 is illustrated, there could be multiple databases, and each AI model 912 may have its own database for training data, model inference, result tracking, etc.

The AI models may utilize the information available in the social networking server 1012, such as the information in databases that include user profile information, user activity information, company information, post information, etc. Thus, when one experience 1106 invokes a model, an input for the model will be the input requesting the inference (e.g., create a subject line for the attached notification), and other inputs for the model may include other related information, such as user ID, segment ID, experiment ID, user profile information, activity of the user information, etc. Based on the input provided, the AI models 912 will generate then the requested output, e.g., the text for the subject of the email.

Over time, the AIMM team develops additional models and makes the new models available to the experience 1106. Additionally, the experience developers may create their own new models, and these models may also be shared with the AIMM 906 and added to the library of available models.

For illustration purposes, a comparison is presented of the effort required to implement a new model by a developer. In conventional model development, without the functionality of AIMM 906, the developer would have had to configure and train a new model from scratch and then integrate the new model with the functionality already provided by the experience. If another developer wanted to use the same model, the other developer will have to also build and train the new model and then integrate the model with their own experience 1106. Further, comparing the performance of different models would require having to set up multiple experiments with the multiple models, and the models could not be run simultaneously, so the result data may not be as precise because each model had a different running environment.

With the AIMM 906, a common training, configuration, and serving infrastructure is available for multiple developers. Further, the models can be shared between experiences (e.g., the same model can be applied to several experiences that send emails), and different models can be ramped to different sub-segments of the same experiences (e.g., country-specific models for generating job alerts). New integrations are not needed to apply models, and the models do not need to be manually re-trained for each different segment: the AIMM 906 will automatically train the models and generate estimates for each segment. Also, multiple models can be ramped to the same audience, and the relative model performance can be compared. The model performance can also be compared to static variants.

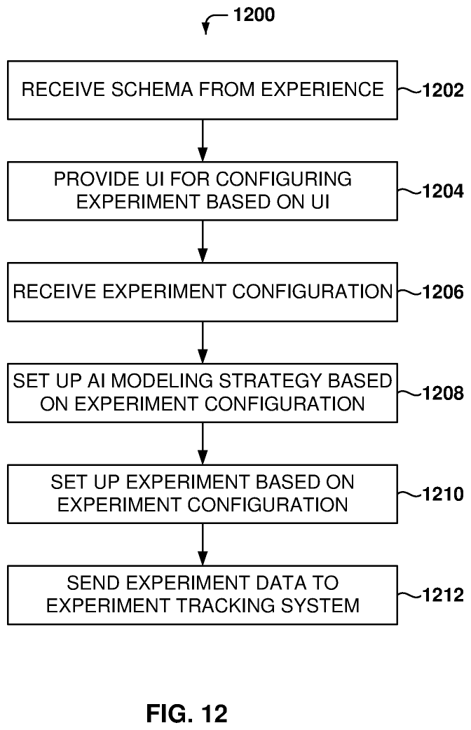

FIG. 12 is a flowchart of a method 1200 for setting up an experiment, according to some example embodiments. While the various operations in this flowchart are presented and described sequentially, one of ordinary skill will appreciate that some or all of the operations may be executed in a different order, be combined or omitted, or be executed in parallel.

At operation 1202, a schema is received from one experience, where the schema defines the parameters for the experiment. As discussed above, at operation 1204, the schema is used to set up the UI for configuring the options of the experiment, including the input fields associated with the schema. The schema may include text, images, videos, sound, etc.

An example of a simple schema for a control variable and two variants would be as follows:

```
CREATE TABLE experiment (
  id INT NOT NULL AUTO_INCREMENT,
  control VARCHAR(255) NOT NULL,
  variant1 VARCHAR(255) NOT NULL,
  variant2 VARCHAR(255) NOT NULL,
  PRIMARY KEY (id)
);
```

This schema defines a table called experiment with four columns: id (ID of the experiment), control (the control variable), variant1 (variant 1 variable), and variant2 (the variant 2 variable).

From operation 1204, the method 1200 flows to operation 1206, where the configuration for the new experiment is received, such as the information described above with reference to FIGS. 4-5.

At operation 1208, the AIMM sets up the AI modeling strategy for running the experiment based on the experiment configuration.

From operation 1208, the method 1200 flows to operation 1210 to set up the new experiment based on the experiment configuration and the AI modeling strategy.

At operation 1212, the experiment information is shared with the experiment tracking system to configure the tracking for the new experiment.

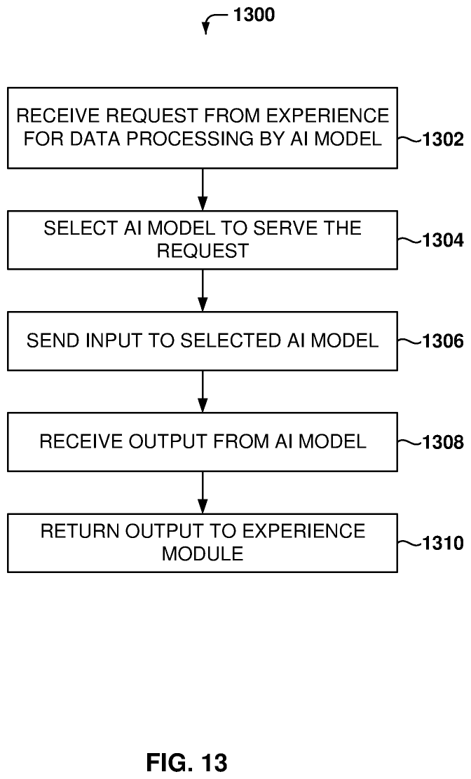

FIG. 13 is a flowchart of a method 1300 for using the AIMM tool during the experiment, according to some example embodiments. While the various operations in this flowchart are presented and described sequentially, one of ordinary skill will appreciate that some or all of the operations may be executed in a different order, be combined or omitted, or be executed in parallel.

At operation 1302, the AIMM receives a request from one of the experiences for data that is generated by one of the configured models. For example, the experience may be sending an email to notify the user that new invitations are waiting, and the experience wants to know the preferred text to send in the email to the specific user. Thus, the experience may pass information including one or more of the experiment ID, the user ID of user receiving the email, the segment ID, and the proposed text.

At operation 1304, the AIMM selects one of the models to generate the response. The AIMM takes into consideration the parameters of the experiment (e.g., percentage of users in the segment ID that are receiving the message created by the particular model) and selects the model. For example, the experiment may have been configured such that 10% of members get variant A, 10% get variant B, and 80% get the control value.

At operation 1306, the input is provided to the selected model, and, at operation 1308, the output of the model is received by the AIMM. The output of the model is then returned, at operation 1310, to the requesting experience. For example, the input may include the text of a message to be sent to a particular user ID for a particular segment ID, and the output may be the text to be sent on the message.

FIG. 14 illustrates the training and use of a machine-learning model, according to some example embodiments. In some example embodiments, machine-learning (ML) models 1416, are utilized to perform operations associated with experiments, such as selecting a piece of text included in a user feed or the subject line for an email message.

Machine Learning (ML) is an application that provides computer systems the ability to perform tasks, without explicitly being programmed, by making inferences based on patterns found in the analysis of data. Machine learning explores the study and construction of algorithms, also referred to herein as tools, that may learn from existing data and make predictions about new data. Such machine-learning algorithms operate by building an ML model 1416 from example training data 1412 in order to make data-driven predictions or decisions expressed as outputs or assessments 1420. Although example embodiments are presented with respect to a few machine-learning tools, the principles presented herein may be applied to other machine-learning tools.

There are two common modes for ML: supervised ML and unsupervised ML. Supervised ML uses prior knowledge (e.g., examples that correlate inputs to outputs or outcomes) to learn the relationships between the inputs and the outputs. The goal of supervised ML is to learn a function that, given some training data, best approximates the relationship between the training inputs and outputs so that the ML model can implement the same relationships when given inputs to generate the corresponding outputs. Unsupervised ML is the training of an ML algorithm using information that is neither classified nor labeled, and allowing the algorithm to act on that information without guidance. Unsupervised ML is useful in exploratory analysis because it can automatically identify structure in data.

Common tasks for supervised ML are classification problems and regression problems. Classification problems, also referred to as categorization problems, aim at classifying items into one of several category values (for example, is this object an apple or an orange?). Regression algorithms aim at quantifying some items (for example, by providing a score to the value of some input). Some examples of commonly used supervised-ML algorithms are Logistic Regression (LR), Naive-Bayes, Random Forest (RF), neural networks (NN), deep neural networks (DNN), matrix factorization, and Support Vector Machines (SVM).

Some common tasks for unsupervised ML include clustering, representation learning, and density estimation. Some examples of commonly used unsupervised-ML algorithms are K-means clustering, principal component analysis, and autoencoders.

In some embodiments, and example ML model 1416 provides a message for a notification that is being sent to a user of the online.

The training data 1412 comprises examples of values for the features 1402. In some example embodiments, the training data comprises labeled data with examples of values for the features 1402 and labels indicating the outcome, such as the user posted a photo, the user accessed the online service in response tool a message from the online service, the user upgraded the level of service, etc. The machine-learning algorithms utilize the training data 1412 to find correlations among identified features 1402 that affect the outcome. A feature 1402 is an individual measurable property of a phenomenon being observed. The concept of a feature is related to that of an explanatory variable used in statistical techniques such as linear regression. Choosing informative, discriminating, and independent features is important for effective operation of ML in pattern recognition, classification, and regression. Features may be of different types, such as, numeric, strings, categorical, and graph. A categorical feature is a feature that may be assigned a value from a plurality of predetermined possible values (e.g., this animal is a dog, a cat, or a bird).

In one example embodiment, the features 1402 may be of different types and may include one or more of user information, responses to notifications, activity information, company information, job information, demographic characteristics, etc.

During training 1414, the ML program, also referred to as ML algorithm or ML tool, analyzes the training data 1412 based on identified features 1402 and configuration parameters defined for the training. The result of the training 1414 is the ML model 1416 that is capable of taking inputs to produce assessments.

Training an ML algorithm involves analyzing large amounts of data (e.g., from several gigabytes to a terabyte or more) in order to find data correlations. The ML algorithms utilize the training data 1412 to find correlations among the identified features 1402 that affect the outcome or assessment 1420. In some example embodiments, the training data 1412 includes labeled data, which is known data for one or more identified features 1402 and one or more outcomes.

The ML algorithms usually explore many possible functions and parameters before finding what the ML algorithms identify to be the best correlations within the data: therefore, training may make use of large amounts of computing resources and time.

When the ML model 1416 is used to perform an assessment, new data 1418 is provided as an input to the ML model 1416, and the ML model 1416 generates the assessment 1420 as output.

In some example embodiments, results obtained by the model 1416 during operation (e.g., assessment 1420 produced by the model in response to inputs) are used to improve the training data 1412, which is then used to generate a newer version of the model. Thus, a feedback loop is formed to use the results obtained by the model to improve the model.

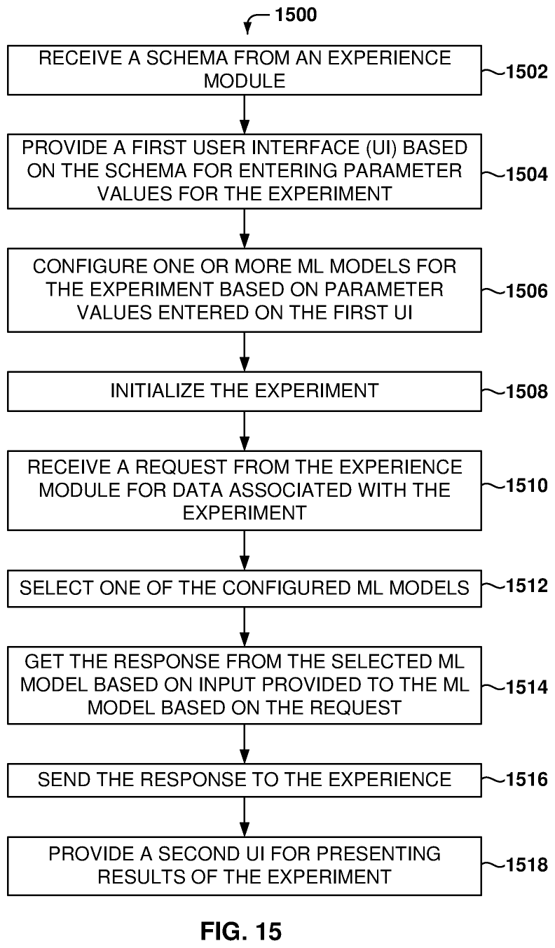

FIG. 15 is a flowchart of a method 1500 for implementing an artificial-intelligence modeling utility system, according to some example embodiments. While the various operations in this flowchart are presented and described sequentially, one of ordinary skill will appreciate that some or all of the operations may be executed in a different order, be combined or omitted, or be executed in parallel.

Operation 1502 is for receiving, by a modeling manager, a schema from an experience module. The experience module implements one or more features of an online service, and the schema is a data structure that defines variables for an experiment. The modeling manager manages a plurality of machine-learning (ML) models.

From operation 1502, the method 1500 flows to operation 1504 to provide, by the modeling manager, a first user interface (UI) based on the schema for entering parameter values for the experiment.

From operation 1504, the method 1500 flows to operation 1506 for configuring one or more ML models from the plurality of ML models for the experiment based on parameter values entered on the first UI.

From operation 1506, the method 1500 flows to operation 1508 to initialize the experiment.

From operation 1508, the method 1500 flows to operation 1510 to, during the experiment, receive, by the modeling manager, a request from the experience module for data associated with the experiment.

From operation 1510, the method 1500 flows to operation 1512 for selecting, by the modeling manager, one of the configured ML models for providing a response to the request.

From operation 1512, the method 1500 flows to operation 1514 for getting the response from the selected ML model based on input provided to the ML model based on the request.

From operation 1514, the method 1500 flows to operation 1516 to send, by the modeling manager, the response to the experience.

From operation 1516, the method 1500 flows to operation 1518 to provide providing a second UI for presenting results of the experiment.

In one example, the modeling manager comprises a common configuration and common infrastructures for managing the plurality of ML models.

In one example, configuring the one or more models comprises: assigning a percentage of requests served by each of the models during the experiment.

In one example, the experiment is for defining text for a notification to be sent to a user, wherein each of the configured ML models provides the text for the notification based on user identification (ID) and segment ID.

In one example, the experiment is for providing multiple options for text on a webpage, wherein the schema defines a control value and one or more variants as the multiple options for the text on the webpage.

In one example, the first UI is provided as a browser extension that provides a toolbar presented with a user feed webpage.

In one example, initializing the experiment comprises: notifying an experiment tracking system of a configuration for the experiment, wherein the second UI is provided by the experiment tracking system.

In one example, the request comprises a user identifier (ID) of a user associated with a communication being sent to the user.

In one example, the request comprises a segment (ID) for a segment of users.

In one example, the modeling manager manages training of the plurality of ML models, wherein the plurality of ML models is available to a plurality of experience modules.

In view of the disclosure above, various examples are set forth below. It should be noted that one or more features of an example, taken in isolation or combination, should be considered within the disclosure of this application.

Another general aspect is for a system that includes a memory comprising instructions and one or more computer processors. The instructions, when executed by the one or more computer processors, cause the one or more computer processors to perform operations comprising: receiving, by a modeling manager, a schema from an experience module, the experience module implementing one or more features of an online service, the schema being a data structure that defines variables for an experiment, the modeling manager managing a plurality of machine-learning (ML) models: providing, by the modeling manager, a first user interface (UI) based on the schema for entering parameter values for the experiment: configuring one or more ML models from the plurality of ML models for the experiment based on the parameter values entered on the first UI: initializing the experiment: during the experiment, receiving, by the modeling manager, a request from the experience module for data associated with the experiment: selecting, by the modeling manager, one of the configured ML models for providing a response to the request: getting the response from the selected ML model based on input provided to the ML model based on the request: sending, by the modeling manager, the response to the experience; and providing a second UI for presenting results of the experiment.

In yet another general aspect, a non-transitory machine-readable storage medium (e.g., a non-transitory storage medium) includes instructions that, when executed by a machine, cause the machine to perform operations comprising: receiving, by a modeling manager, a schema from an experience module, the experience module implementing one or more features of an online service, the schema being a data structure that defines variables for an experiment, the modeling manager managing a plurality of machine-learning (ML) models; providing, by the modeling manager, a first user interface (UI) based on the schema for entering parameter values for the experiment: configuring one or more ML models from the plurality of ML models for the experiment based on the parameter values entered on the first UI: initializing the experiment: during the experiment, receiving, by the modeling manager, a request from the experience module for data associated with the experiment: selecting, by the modeling manager, one of the configured ML models for providing a response to the request; getting the response from the selected ML model based on input provided to the ML model based on the request: sending, by the modeling manager, the response to the experience; and providing a second UI for presenting results of the experiment.

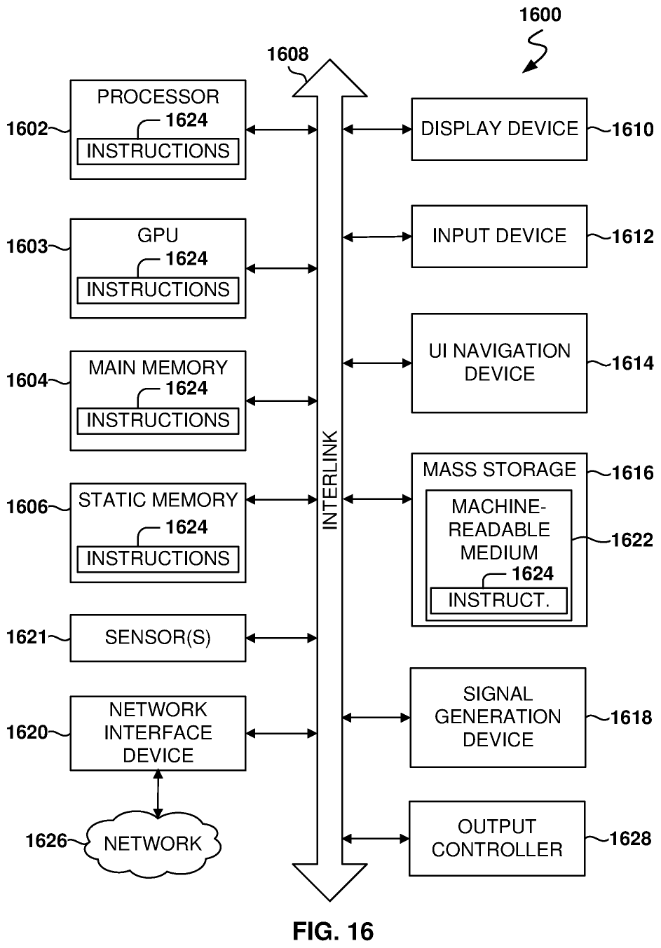

FIG. 16 is a block diagram illustrating an example of a machine 1600 upon or by which one or more example process embodiments described herein may be implemented or controlled. In alternative embodiments, the machine 1600 may operate as a standalone device or may be connected (e.g., networked) to other machines. In a networked deployment, the machine 1600 may operate in the capacity of a server machine, a client machine, or both in server-client network environments. In an example, the machine 1600 may act as a peer machine in a peer-to-peer (P2P) (or other distributed) network environment. Further, while only a single machine 1600 is illustrated, the term “machine” shall also be taken to include any collection of machines that individually or jointly execute a set (or multiple sets) of instructions to perform any one or more of the methodologies discussed herein, such as via cloud computing, software as a service (SaaS), or other computer cluster configurations.

Examples, as described herein, may include, or may operate by, logic, various components, or mechanisms. Circuitry is a collection of circuits implemented in tangible entities that include hardware (e.g., simple circuits, gates, logic). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits) including a computer-readable medium physically modified (e.g., magnetically, electrically, by moveable placement of invariant massed particles) to encode instructions of the specific operation. In connecting the physical components, the underlying electrical properties of a hardware constituent are changed (for example, from an insulator to a conductor or vice versa). The instructions enable embedded hardware (e.g., the execution units or a loading mechanism) to create members of the circuitry in hardware via the variable connections to carry out portions of the specific operation when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry, at a different time.

The machine 1600 (e.g., computer system) may include a hardware processor 1602 (e.g., a central processing unit (CPU), a hardware processor core, or any combination thereof), a graphics processing unit (GPU 1603), a main memory 1604, and a static memory 1606, some or all of which may communicate with each other via an interlink 1608 (e.g., bus). The machine 1600 may further include a display device 1610, an alphanumeric input device 1612 (e.g., a keyboard), and a user interface (UI) navigation device 1614 (e.g., a mouse). In an example, the display device 1610, alphanumeric input device 1612, and UI navigation device 1614 may be a touch screen display. The machine 1600 may additionally include a mass storage device 1616 (e.g., drive unit), a signal generation device 1618 (e.g., a speaker), a network interface device 1620, and one or more sensors 1621, such as a Global Positioning System (GPS) sensor, compass, accelerometer, or another sensor. The machine 1600 may include an output controller 1628, such as a serial (e.g., universal serial bus (USB)), parallel, or other wired or wireless (e.g., infrared (IR), near field communication (NFC)) connection to communicate with or control one or more peripheral devices (e.g., a printer, card reader).

The mass storage device 1616 may include a machine-readable medium 1622 on which is stored one or more sets of data structures or instructions 1624 (e.g., software) embodying or utilized by any one or more of the techniques or functions described herein. The instructions 1624 may also reside, completely or at least partially, within the main memory 1604, within the static memory 1606, within the hardware processor 1602, or within the GPU 1603 during execution thereof by the machine 1600. In an example, one or any combination of the hardware processor 1602, the GPU 1603, the main memory 1604, the static memory 1606, or the mass storage device 1616 may constitute machine-readable media.

While the machine-readable medium 1622 is illustrated as a single medium, the term “machine-readable medium” may include a single medium, or multiple media, (e.g., a centralized or distributed database, and/or associated caches and servers) configured to store the one or more instructions 1624.

The term “machine-readable medium” may include any medium that is capable of storing, encoding, or carrying instructions 1624 for execution by the machine 1600 and that cause the machine 1600 to perform any one or more of the techniques of the present disclosure, or that is capable of storing, encoding, or carrying data structures used by or associated with such instructions 1624. Non-limiting machine-readable medium examples may include solid-state memories, and optical and magnetic media. In an example, a massed machine-readable medium comprises a machine-readable medium 1622 with a plurality of particles having invariant (e.g., rest) mass. Accordingly, massed machine-readable media are not transitory propagating signals. Specific examples of massed machine-readable media may include non-volatile memory, such as semiconductor memory devices (e.g., Electrically Programmable Read-Only Memory (EPROM), Electrically Erasable Programmable Read-Only Memory (EEPROM)) and flash memory devices: magnetic disks, such as internal hard disks and removable disks; magneto-optical disks; and CD-ROM and DVD-ROM disks.

The instructions 1624 may further be transmitted or received over a communications network 1626 using a transmission medium via the network interface device 1620.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Additionally, as used in this disclosure, phrases of the form “at least one of an A, a B, or a C,” “at least one of A, B, and C,” and the like, should be interpreted to select at least one from the group that comprises “A, B, and C.” Unless explicitly stated otherwise in connection with a particular instance, in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A computer-implemented method comprising:
receiving, by a modeling manager, a schema from an experience module, the experience module implementing one or more features of an online service, the schema being a data structure that defines variables for an experiment, the modeling manager managing a plurality of machine-learning (ML) models;
providing, by the modeling manager, a first user interface (UI) based on the schema for entering parameter values for the experiment;
configuring one or more ML models from the plurality of ML models for the experiment based on the parameter values entered on the first UI;
initializing the experiment;
during the experiment, receiving, by the modeling manager, a request from the experience module for data associated with the experiment;
selecting, by the modeling manager, one of the configured ML models for providing a response to the request;
getting the response from the selected ML model based on input provided to the ML model based on the request;
sending, by the modeling manager, the response to the experience; and
providing a second UI for presenting results of the experiment.

2. The method as recited in claim 1, wherein the modeling manager comprises a common configuration and common infrastructures for managing the plurality of ML models.

3. The method as recited in claim 1, wherein configuring the one or more models comprises:
assigning a percentage of requests served by each of the models during the experiment.

4. The method as recited in claim 1, wherein the experiment is for defining text for a notification to be sent to a user, wherein each of the configured ML models provides the text for the notification based on user identification (ID) and segment ID.

5. The method as recited in claim 1, wherein the experiment is for providing multiple options for text on a webpage, wherein the schema defines a control value and one or more variants as the multiple options for the text on the webpage.

6. The method as recited in claim 1, wherein the first UI is provided as a browser extension that provides a toolbar presented with a user feed webpage.

7. The method as recited in claim 1, wherein initializing the experiment comprises:
notifying an experiment tracking system of a configuration for the experiment, wherein the second UI is provided by the experiment tracking system.

8. The method as recited in claim 1, wherein the request comprises a user identifier (ID) of a user associated with a communication being sent to the user.

9. The method as recited in claim 1, wherein the request comprises a segment (ID) for a segment of users.

10. The method as recited in claim 1, wherein the modeling manager manages training of the plurality of ML models, wherein the plurality of ML models is available to a plurality of experience modules.

11. A system comprising:
a memory comprising instructions; and
one or more computer processors, wherein the instructions, when executed by the one or more computer processors, cause the system to perform operations comprising:
receiving, by a modeling manager, a schema from an experience module, the experience module implementing one or more features of an online service, the schema being a data structure that defines variables for an experiment, the modeling manager managing a plurality of machine-learning (ML) models;
providing, by the modeling manager, a first user interface (UI) based on the schema for entering parameter values for the experiment;
configuring one or more ML models from the plurality of ML models for the experiment based on the parameter values entered on the first UI;
initializing the experiment;
during the experiment, receiving, by the modeling manager, a request from the experience module for data associated with the experiment;
selecting, by the modeling manager, one of the configured ML models for providing a response to the request;
getting the response from the selected ML model based on input provided to the ML model based on the request;
sending, by the modeling manager, the response to the experience; and
providing a second UI for presenting results of the experiment.

12. The system as recited in claim 11, wherein the modeling manager comprises a common configuration and common infrastructures for managing the plurality of ML models.

13. The system as recited in claim 11, wherein configuring the one or more models comprises:
assigning a percentage of requests served by each of the models during the experiment.

14. The system as recited in claim 11, wherein the experiment is for defining text for a notification to be sent to a user, wherein each of the configured ML models provides the text for the notification based on user identification (ID) and segment ID.

15. The system as recited in claim 11, wherein the experiment is for providing multiple options for text on a webpage, wherein the schema defines a control value and one or more variants as the multiple options for the text on the webpage.

16. A non-transitory machine-readable storage medium including instructions that, when executed by a machine, cause the machine to perform operations comprising:
receiving, by a modeling manager, a schema from an experience module, the experience module implementing one or more features of an online service, the schema being a data structure that defines variables for an experiment, the modeling manager managing a plurality of machine-learning (ML) models;
providing, by the modeling manager, a first user interface (UI) based on the schema for entering parameter values for the experiment;
configuring one or more ML models from the plurality of ML models for the experiment based on the parameter values entered on the first UI;
initializing the experiment;
during the experiment, receiving, by the modeling manager, a request from the experience module for data associated with the experiment;
selecting, by the modeling manager, one of the configured ML models for providing a response to the request;
getting the response from the selected ML model based on input provided to the ML model based on the request;
sending, by the modeling manager, the response to the experience; and
providing a second UI for presenting results of the experiment.

17. The non-transitory machine-readable storage medium as recited in claim 16, wherein the modeling manager comprises a common configuration and common infrastructures for managing the plurality of ML models.

18. The non-transitory machine-readable storage medium as recited in claim 16, wherein configuring the one or more models comprises:
assigning a percentage of requests served by each of the models during the experiment.

19. The non-transitory machine-readable storage medium as recited in claim 16, wherein the experiment is for defining text for a notification to be sent to a user, wherein each of the configured ML models provides the text for the notification based on user identification (ID) and segment ID.

20. The non-transitory machine-readable storage medium as recited in claim 16, wherein the experiment is for providing multiple options for text on a webpage, wherein the schema defines a control value and one or more variants as the multiple options for the text on the webpage.
